(19) United States
(12) Patent Application Publication
(10) Pub. No.: US 2026/0221835 A1
(43) Pub. Date: Jul. 30, 2026

(54) MOTOR DEVICE WITH A MULTI-FUNCTIONAL INTERMEDIATE UNIT ARRANGED BETWEEN A MOTOR UNIT AND A SERVO DRIVE UNIT OF THE MOTOR DEVICE

(71) Applicant: Synapticon GmbH, Schönaich (DE)

(72) Inventors: Kilian PELTZER, Schönaich (DE); Simon FISCHINGER, Schönaich (DE); Nathanael PELTZER, Schönaich (DE); Florian KOCK, Schönaich (DE)

(21) Appl. No.: 18/721,522

(22) PCT Filed: Dec. 14, 2022
(86) PCT No.: PCT/IB2022/062215

§ 371 Date: Jun. 18, 2024

(30) Foreign Application Priority Data
Dec. 21, 2021 (DE) 10 2021 133 952.9

(51) Int. Cl. H02K 5/02; H02K 11/00; H02K 11/01

(52) U.S. Cl. CPC H02K 5/02; H02K 11/0094; H02K 11/01; H02K 2211/03

(57) ABSTRACT

The disclosure relates to Motor device (1) with a motor unit (2) and a servo drive unit (3) attached to the motor unit (2), wherein: the servo drive unit (3) comprises a servo drive housing (3A) and a first printed circuit board (3B) with one or more electronic elements (3C); the motor unit (2) comprises a motor housing (2A) and a rotor; and an intermediate unit (4) is arranged between the motor unit (2) and at least a first part of the servo drive unit (3), with a main extension plane perpendicular to an axial direction (A) of the rotor; where the intermediate unit (4) is a multi-functional intermediate unit (4) which comprises an injection-mold element (5), the intermediate unit (4) being configured to provide at least two of the following functionalities: i) a sealing functionality, with the intermediate unit (4) configured to seal a body of the motor device against an external environment; ii) an electromagnetic shielding functionality, with the intermediate unit (4) configured to electromagnetically shield at least the first part of the servo drive unit (3) from the motor unit (2); iii) a thermal insulation functionality, with the intermediate unit (4) configured to thermally insulate at least the first part of the servo drive unit (3) from the motor unit (2); iv) a light guide functionality, with the intermediate unit (4) configured to guide light emitted inside the motor device (1) to the external environment of the motor device (1); v) a load bearing functionality, with the intermediate unit (4) configured to be a load bearing part of the motor device (1) in order to provide a motor device (1) with a motor unit (2) and a servo drive unit (3) attached to the motor unit (2) that can be assembled in a simple and fail-safe mounting procedure.

### FIELD OF INVENTION

The disclosure relates to a motor device with a motor unit and a servo drive unit attached to the motor unit, wherein the servo drive unit comprises a servo drive housing and a first printed circuit board with one or more electronic elements, the motor unit comprises a motor housing and a rotor, and an intermediate unit is arranged between the motor unit and at least a first part of the servo drive unit, the intermediate unit having a main extension plane perpendicular to an axial direction of the rotor.

In some known inverter motor devices, that is, motor devices with integrated inverter elements and/or integrated other power electronics, use an intermediate unit as a thermal insulation layer in order to shield the electronic elements of the servo drive unit from the heat of the motor. This insulation layer or intermediate unit is typically made as a single component of polymer, with the sole purpose of providing thermal isolation.

Furthermore, the known inverter motor devices have severeal different housing parts forming the housing or body of the complete motor device, i.e. the total motor device housing. The body of the complete motor device requires significant effort to achieve a desired level of ingress protection. Usually gaskets are provided between the different body parts (the housings of the different units) to seal off the housing of the inverter elements, in particular the servo drive housing and/or the motor housing. These gaskets generally consist of cut-out sheets of an elastomer polymer that are stacked in a mounting procedure of the motor device on top of the insulation layer, i.e. the intermediate unit. This mounting procedure is time intensive and prone to mounting mistakes that render the gasket ineffective.

Alternatively, the entire electronics housing, for instance servo drive housing and/or motor housing can be potted, but such processes again are time-consuming, expensive, and involve the use of hazardous, environmentally harmful substances. Glue or liquid gaskets between the different body parts / housings are another option. However, this hazard time intensive step during the assembly. Therefore, for low levels of ingress protection, it is refrained from any particular measure, with the different body parts just being put together directly.

The problem of the time-intensive mounting procedure that is prone to mounting mistakes and endangering ingress protection, is aggravated by motor devices usually having one or several light emitting diodes, LEDs, optically indicating a status of the motor device. These LEDs are generally installed on the backside of an inverter element and visible from the outside, i.e. an external environment of the motor device, and useful for communicating the devices status to a user by means of an optical code. However, these LEDs require another opening in the body of the motor device that need to be sealed, with additional parts and effort in the mounting process of the motor device.

An exemplary inverter motor device with a thermally insulating intermediate unit is shown in the EP 3 183 800 A1.

The objective technical problem to be solved by the invention at hand can therefore be regarded to provide a motor device with a motor unit and a servo drive unit attached to the motor unit that can be assembled in a simple and fail-safe mounting procedure, that is, in a mountain procedure that is less time intensive and less prone to mounting mistakes than the known approaches.

### SUMMARY OF THE INVENTION

This problem is solved by the subject-matter of the independent claim. Advantageous embodiments are apparent from the dependent claims, the description, and the figures.

One aspect relates to a motor device with a motor unit and a servo drive unit attached to the motor unit. The motor device may be referred to as inverter motor device, as the motor device comprises one or more inverter elements as power electronic elements. The servo drive unit comprises a servo drive housing and a first printed circuit board with one or more electronic elements. These electronic elements may be control elements, preferably only control elements, as opposed to power electronic elements. The servo drive housing is, in the assembled state of the motor device, part of the housing of the entire motor device, that is, the total motor device housing which is referred to as body of the motor device in the following to avoid confusion with the housings of the individual units such as servo drive unit and motor unit. The servo drive unit may comprise two parts. Then, said first printed circuit board with the one or more electronic elements is arranged in the first part of the servo drive unit. The second part of the servo drive unit may comprise a second printed circuit board with one or more power electronic elements such as inverter elements. The first part of the servo drive unit preferably is more remote from the motor unit than the second part of the servo drive unit.

The motor unit comprises a motor housing, the motor housing with a stator, as well as a rotor. Optionally, the motor unit may comprise an electromagnetically actuated brake.

Similar to the servo drive housing, the motor housing is part of the body of the motor device when the motor device is assembled. As an alternative to the configuration with the inverter elements in the second part of the servo drive unit, the second printed circuit board with the power electronics, in particular the inverter elements, may be part of the motor unit.

Between the motor unit and the servo drive unit, i.e. at least the first part of the servo drive unit, an intermediate unit is arranged. This intermediate unit has a main extension plane which runs perpendicular to an axial direction of the rotor. Consequently, its extension perpendicular to the axial direction is significantly larger than its extension in the axial direction. For instance, the extension perpendicular to the axial direction may be more than 2 times, preferably more than 5 times the extension in the axial direction. In particular, the extension in the axial direction, i.e. thickness, of the intermediate unit may be more than 3 mm and/or less than 20 mm. In the main extension plane, the intermediate unit may cover an area of more than 50×50 mm² and/or less than 100×100 mm². The intermediate unit may have an essentially rectangular, e.g. rectangular or quadratic diameter, eventually with rounded edges; preferably with sides longer than 50 mm and or less than 100 mm.

The intermediate unit may be arranged in between the complete servo drive unit and the motor unit, that is, with first and second part, if available, of the servo drive unit on one side of the intermediate unit, and the motor unit on the other side of the intermediate unit. Alternatively, the intermediate unit may be arranged such that the first part of the servo drive unit is arranged on the one side of the intermediate unit and the second part of the servo drive unit as well as the motor unit are arranged on the other side of the intermediate unit. Thus, the intermediate unit may separate the motor unit from servo drive unit or the first part of the servo drive unit from motor unit and second part of the servo drive unit.

Therein, the intermediate unit is a multi-functional intermediate unit which comprises an injection-mold element, with the intermediate unit being configured to provide at least two, preferably at least three, more preferably at least four, most preferably all, of the functionalities explained in the following:
A thermal insulation functionality, with the intermediate unit configured to thermally insulate at least the first part of the servo drive unit from the motor unit. Consequently, the intermediate unit may be configured to thermally insulate the first part of the servo drive unit from both the motor unit and the second part of the servo drive unit, or configured to thermally insulate the servo drive unit as a whole, that is the first part and the second part of the servo drive unit, from the motor unit. To this end, the material and/or a mechanical structure of the intermediate unit may have a thermal conductivity lower than the material and/or mechanical structure of the servo drive unit and/or the motor unit, in particular the respective motor housing and/or servo drive housing.
An electromagnetic shielding functionality, with the intermediate unit configured to electromagnetically shield at least the first part of the servo drive unit from the motor unit. Similar to the thermal insulation functionality, this functionality may, depending on the arrangement of the intermediate unit, be provided between servo drive unit on one side of the intermediate unit and motor unit on the other side of the intermediate unit, or between first part of the servo drive unit on one side of the intermediate unit and second part of the servo drive unit and motor unit on the other side of the intermediate unit.
A sealing functionality, with the intermediate unit configured to seal the body of the motor device against an external environment, in particular, dust and/or humidity from that external environment. Similar to the other functionalities, this functionality may, depending on the arrangement of the intermediate unit, be provided between servo drive unit on one side of the intermediate unit and motor unit on the other side of the intermediate unit, or between first part of the servo drive unit on one side of the intermediate unit and second part of the servo drive unit and motor unit on the other side of the intermediate unit.
A light guide functionality, with the intermediate unit configured to guide light emitted from a light source inside the body of the motor device to the external environment of the motor device. As the other functionalities, this functionality may, depending on the arrangement of the intermediate unit, be provided between servo drive unit on one side of the intermediate unit and motor unit on the other side of the intermediate unit, or between first part of the servo drive unit on one side of the intermediate unit and second part of the servo drive unit and motor unit on the other side of the intermediate unit.
A load bearing functionality, that is, support functionality, contributing to the structural integrity and/or mechanical stability of the body of the motor device, with the intermediate unit configured to be a load bearing or supporting part of the motor device, in particular the body of the motor device. Just as the other functionalities, this functionality may, depending on the arrangement of the intermediate unit, be provided between servo drive unit on one side of the intermediate unit and motor unit on the other side of the intermediate unit, or between first part of the servo drive unit on one side of the intermediate unit and second part of the servo drive unit and motor unit on the other side of the intermediate unit.

So, the invention is based on the insight that the intermediate unit that is commonly only a simple, non-translucent, single component polymer part providing a thermal insulation functionality only, is actually well-suited to provide for several other functionalities at the same time, where said functionalities can be achieved with small effort and even reduce the number of parts that need to be assembled when manufacturing the motor device. Instead of the time-consuming manufacturing process involving lots of different components and parts, the invention allows to implement additional functionalities without any additional parts during the manufacturing process. Namely, all additional functionalities relate to the design and manufacturing of the intermediate unit, as well as, if required, the servo drive unit and motor units, prior to the mounting process and do not require additional parts or manufacturing steps as compared to the conventional manufacturing/mounting of the motor device. For some functionalities, the injection-mold element may be required to be a multi-component injection-mold element, but this does not pose any problem, since injection-molding is a well-developed technology. The solution proposed thus saves assembly time and time required for training the manufacturing personal. Consequently, it provides a motor device with a motor unit and a servo drive unit attached to the motor unit that can be assembled in a simple and fail-safe mounting procedure.

In an advantageous embodiment, in order to provide the sealing functionality, the injection-mold element is a multi-component injection-mold element which comprises a first soft component, e.g. an elastomer, that is part of or forms a first circumferential seal, a second soft component, e.g. the same or another elastomer, that is part of or forms a second circumferential seal, which is separated from the first circumferential seal, and a hard component, for instance, a polymer or a glass, that is part of or forms a circumferential body section of the body of the motor device. The hard component may be referred to as first hard component or comprise one or more (first, second, . . . ) hard components. Any hard component of the injection-mold element may be harder than the soft components. The circumferential section of the body may be shaped as or similar to a ring, for instance a rectangular ring with rounded corners. The soft components are softer than the hard component, and the first circumferential seal is sealing a gap between the servo drive housing and the circumferential body section, and the second circumferential seal is sealing a gap between the circumferential body section and the motor housing. Consequently, the body is sealed in the respective areas between circumferential body section, that is, intermediate unit, and servo drive housing and motor housing, respectively, that is, servo drive unit and motor unit. The problem of the multi-part gaskets is overcome by integrating the gasket in the intermediate unit present in some known inverter motor devices (usually providing thermal insulation) anyway. The flexible parts, the soft components, provide the sealing, and the rigid part, the hard component, provides support for the sealing. The hard component can also provide one or more of the other functionalities without degrading the sealing functionality, as apparent from the rest of the description. Also, by sealing the body of the motor device as whole, it is not required to seal the individual units, i.e. servo drive unit and/or motor unit. This is particularly advantageous for the motor units B-side, its “backplate”, with all its openings for motor shaft and electric connectors, as this inner side of the motor unit does not need to be sealed here, neither does the surface plane of the servo drive unit facing towards the motor. Thus, again time is saved and complexity reduced, which makes the mounting more failsafe. So, the additional functionality is embodied in a simple and reliable way.

In another advantageous embodiment, in order to provide the electromagnetic shielding functionality, a ferromagnetic shielding element such as a metal sheet is, in part or completely, overmold by the injection-mold element, which preferably may be a multi-component injection-mold element, for instance, as described in the last paragraph. Therein, the ferromagnetic shielding element may be overmold by the hard component, or another hard component, i.e. any hard component part of the injection-mold element. A suitable (preferably hard) component may be a polymer. Preferably, the ferromagnetic shielding element has a main extension plane running perpendicular to the axial direction the rotor. This provides two main advantages achieved in a simple and effective manner. Firstly, a ferromagnetic shielding of the electronic elements of the servo drive unit from the motor unit is achieved. This is particularly advantageous when the inverter motor device is equipped with an electromagnetically actuated brake and the servo drive unit is equipped with a magnetic sensor system, for instance, for angle or current reading. Namely, these two systems need to be magnetically shielded from each other to avoid disturbances of the sensor caused by stray fields of the magnetic field of the brake. Conventionally, a magnetic insulation layer for shielding against such fields has to be attached separately to the housing or has to completely cover the housing of the brake in the known solutions, which negatively affects terminals, aesthetics, and production cost. Secondly, the overmolding prevents the shielding element from corrosion. Therefore, a treatment of the ferromagnetic shielding element such as protective coating or alike known from the state-of-the-art is rendered obsolete. Again, the additional functionality is embodied in a simple and reliable way.

In another advantageous embodiment, in order to provide the thermal insulation functionality, the injection-mold element comprises a multitude of blind holes, that is, a multitude of adjacent blind holes, which may be of arbitrary shape, separated by walls which are formed by the injection-mold element, preferably hard component of the injection-mold element. Also, in this case, the injection-mold element, preferably is or comprises the multi-component injection-mold element described above, which fosters the integration of different functionalities. In particular, the multitude of blind holes may be arranged in a honeycomb structure, that is, the blind holes may form cavities that are separate from each other by walls with the open side orientated in the same direction, as the individual combs in a honeycomb structure. However, as the blind holes may be of arbitrary shape, for instance a rectangular shape, the holes do not need to be arranged in a hexagonal structure. Preferably, the blind holes are open in the direction towards the motor unit, with a housing of the motor unit or a second printed circuit board of the motor unit or of the servo drive unit (preferably of the second part of the servo drive unit if the servo drive unit is divided into two parts by the intermediate unit) closing said blind holes in the assembled state of the motor device in order to keep air exchange between the blind holes low. This makes the insulating intermediate unit, which thermally separates a hotter zone and a colder zone of the inverter motor device more efficient without adding significant weight as the blind holes provide separate compartments for air, which provides good thermal insulation. The hotter zone typically including the motor unit and motor itself, and the colder zone typically including the electronic (control) elements like microcontrollers, encoders or communication devices. The inverter itself can be located either in the hotter zone or in the colder zone-preferably in the hotter zone, thermally well-connected to the motor unit or part of the motor unit. Since the air is caught in separate compartments, it cannot be exchanged between the different temperature zones, and cannot move, to a significant extent, along the hotter and colder parts, i.e. part belonging to the hotter or colder zone.

In another advantageous embodiment, in order to provide the light guide functionality, a component of the injection-mold element, preferably an addition (preferably hard) component or the hard component from above, is made of a translucent material, preferably plastic or glass, and shaped such that a light emitted by at least one light source arranged on the first printed circuit board, i.e. inside the motor device, is guided to an external environment of the motor device. Firstly, this gives the advantage that no additional hole has to be provided by the housing of the servo drive unit, which makes the production and assembly more simple and efficient. Secondly, the possibilities for designing the light emittance into the external environment are increased, which allows, for instance, as described in the following, light to be emitted in more than one direction even with only one LED as light source, i.e. the size of illuminated area per LED can be increased. If several LEDs are utilised, the light of each of the LEDs may be guided to different sides of the motor device, which increases both the amount of information that can be transmitted to the environment and the reliability of the information transmittal. The latter due to the increased visibility, which can be achieved in the state-of-the-art only by several redundant LEDs arranged on different sides of the body of the motor device (which comes with the disadvantages described above). The former as the functional redundancy of the available number of LEDs can be reduced, which frees LEDs for increased information signaling. Consequently, the LEDs may be used for light animations that encode respective information regarding the state of the device. For instance, the LEDs may be configured to indicate an optical pattern that moves circumferentially around the device. Preferably, the LEDs are mounted on the same printed circuit board.

Correspondingly, the translucent material, i.e. the component made of translucent plastic or glass, may form an outer surface of the motor device, that is, part of the outer surface of the body of the motor device, which at least in part runs around the motor device in a circumferential direction. So, the outer surface formed by the translucent material runs around the motor device, preferably in a tangential plane perpendicular to the axial direction. In particular, the translucent outer surface may run around the motor device in the circumferential direction for more than 180°, preferably more than 270°, most preferably for more than 350° or for 360°. Consequently, light can be emitted radially in any desired set of directions, even all radial directions. The outer surface formed by the translucent material may be of a ring-like shape, such that, in the axial direction, a section of the body of the motor device is formed by said translucent material. Consequently, as the ring-like shape advantageously is adapted to the corresponding cross-sectional shape of motor housing and/or servo drive housing, when lit by the at least one light source of the first printed circuit board, the translucent surface of the housing reliably can transmit status information indicated by said light which is visible from almost every angle, even with a single LED light source.

In particular, the translucent component, preferably hard component, comprises a first clear section and a second, preferably turbid (milky), section, with the first clear section being arranged, along the path of the light from the light source to the external environment, between the light source and the second, preferably turbid, section, and the second, preferably turbid, section between the first clear section and the external environment. So, the translucent component acts as a light guide and as a reflector to give a smooth and evenly distributed appearance when lit. The second section may be turbid or clear.

Preferably, the at least one light source is several light sources, and the light sources are, in a plane perpendicular to the axial direction, either not arranged on a circle and not arranged on a straight line, or arranged on a circle but not positioned equidistant on the circle. These arrangements have been proven to be particularly advantageous when it comes to an even light distribution on the outer surface of the motor device, in particular when the shape of the outer surface made of the translucent plastic is adapted to the shape(s) of the adjacent servo drive housing and/or motor housing when these housings are not round in a cross-section perpendicular to the axial direction.

Consequently, in particular, the (preferably hard) component of translucent plastic may have a noncircular outer perimeter, preferably an essentially rectangular outer perimeter, such as an rectangular perimeter with rounded corners. Therein, the outer perimeter limits the heart components translucent plastic against the external environment.

In an advantageous embodiment, the injection-mold element is a multi-component injection-mold element and comprises, in addition to the (preferably hard) translucent component, a thermally insulating component, which is another (preferably hard) component, which is made of a plastic with a thermal conductivity that is lower than the thermal conductivity of the plastic of the translucent component and/or with more stable mechanical properties than the translucent component, in particular at high temperatures. This is particularly advantageous, as both the light guide functionality, and the thermal insulation functionality are realized (or, in the latter case, improved) within one single element.

In another advantageous embodiment, in order to provide the load bearing or support functionality, the injection-mold element, preferably at least one of the (preferably hard) components described above, features an alignment structure for aligning servo drive unit and/or motor unit with the intermediate unit by means of a form-fit mechanical interaction (that is, a positive material connection) with the servo drive unit, in particular the servo drive housing and/or the first printed circuit board, and/or the motor unit, in particular the motor housing and/or the second printed circuit board. Such a form-fit mechanical interaction may be realized by one or more protrusions such as pins protruding from one of the units into respective receptacles such as holes of the other unit, and/or by one or more edges of one unit being configured to form-fit a corresponding groove of the other unit. This gives the advantage of an even further integrated motor device with multi-functional intermediate unit, where connecting means such as screws can be reduced in number.

Other aspects relate to an intermediate unit and/or a servo drive unit and/or motor unit for a motor device of any of the described embodiments.

The features and combinations of features described above, also in the general intro as well as the features and combinations of features disclosed in the figure description or the figures alone may not only be used alone or in the described combination, but also with other features or without some of the disclosed features without leaving the scope of the invention. Consequently, embodiments that are not explicitly shown and described by the figures but that can be generated by separately combining the individual features disclosed in the figures are also part of the invention. Therefore, embodiments and combinations of features that do not comprise all features of an originally formulated independent claim are to be regarded as disclosed. Furthermore, embodiments and combinations of features that differ from or extend beyond the combinations of features described by the dependencies of the claims are to be regarded as disclosed.

### DETAILED DESCRIPTION

Exemplary embodiments are further described in the following by means of schematic drawings. Therein,

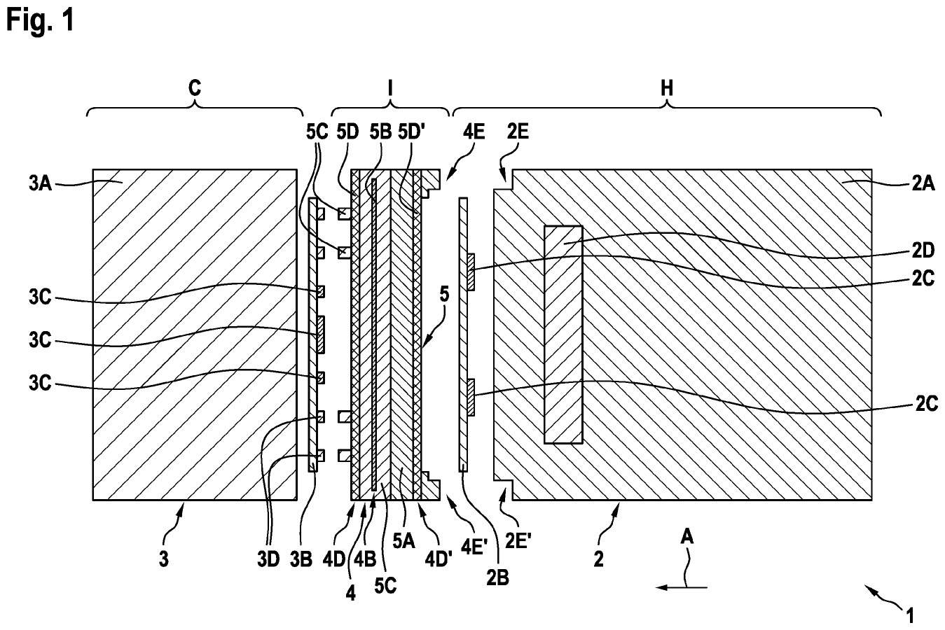

FIG. 1 shows an exploded view of an exemplary embodiment of a motor device;

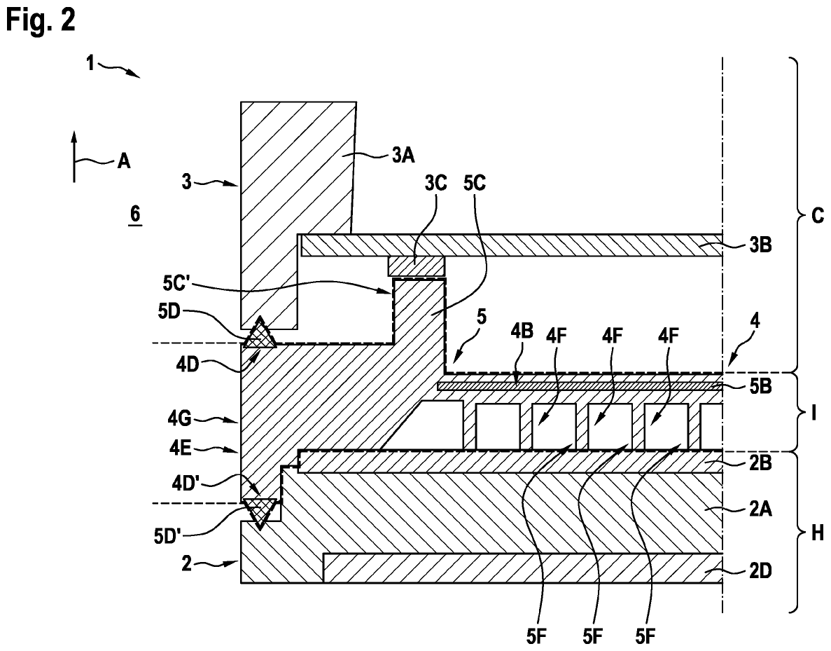

FIGS. 2-7 show respective cross-sections of exemplary variations of motor devices; and

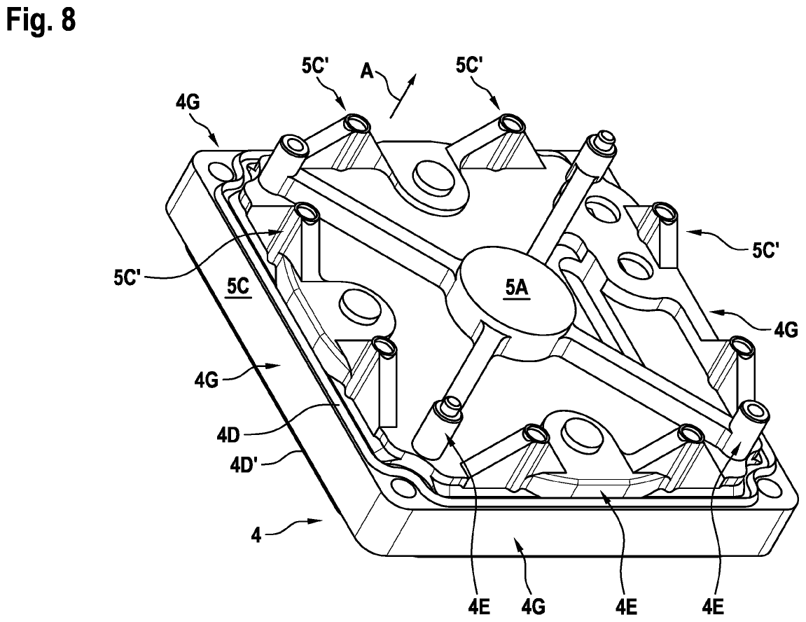

FIG. 8 shows a perspective view on an exemplary embodiment of an intermediate unit.

In the figures, the same or functionally identical features are given the same reference signs.

FIG. 1 shows an exemplary embodiment of a motor device 1 with a motor unit 2, and a servo drive unit 3 attached to the motor unit 2 in an exploded view of an axial direction A of the motor unit 2. Therein, the servo drive unit 3 comprises a servo drive housing 3A, and a first printed circuit board 3B with one or more electronic elements 3C. In the present example, the first printed circuit board 3B also features at least one light source 3D, in the present case in the form of four LEDs.

The motor unit 2 comprises a motor housing 2A as well as a rotor which is located in the housing 2A and not depicted in the figure. Furthermore, in the present example, the motor unit 2 also comprises a second printed circuit board 2B with one or more inverter elements 2C as power electronics. Thus, the second printed circuit 2B board is a dedicated board for inverter elements 2C. In addition, the present example, the motor unit 2 comprises an electromagnetically activated break 2D.

In between motor unit 2 and at least a first part of the servo drive unit 3, in the present example the only part of the servo drive unit 3, i.e. the complete servo drive unit 3, an intermediate unit 4 is arranged. This intermediate unit 4 has a main extension plane perpendicular to the axial direction A of the rotor, that is, the axial direction A of the motor unit 2. The intermediate unit 4 is a multi-functional intermediate unit 4. This multi-functional intermediate unit 4 comprises an injection-mold element 5, is actually made of said injection-mold element 5 in the present example.

The intermediate unit 4 is configured to provide at least two, preferably three or more of the following functionalities, namely: i) a sealing functionality, ii) an electromagnetic shielding functionality, iii) a thermal insulation functionality, iv) a light guide functionality, v) a load bearing functionality.

In the present example, a thermally nonconductive polymer material as a component 5A, contributes to the thermal insulation functionality. The electromagnetic shielding functionality is provided by a metal sheet 5B as ferromagnetic shielding element 4B. The light guide functionality is provided by a translucent plastic component 5C.

The sealing functionality is provided by a first soft component 5D being part of, in the present example forming a first circumferential seal 4D and a second soft component 5D′ being part of in the present example forming a second circumferential seal 4D′. The soft components 5D, 5D′ contribute to the sealing functionality as they are pressed against housing 3A and housing 2A, respectively, by the components 5A, 5C which are harder than the soft components 5D, 5d′ and may thus referred to as hard components 5A, 5C.

The load bearing functionality is provided by respective alignment structures 4E, 4E′ of the intermediate unit 4 that mechanically interact with corresponding structures of servo drive unit 3 and/or motor unit 2, here grooves 2E, 2E′ of the motor unit 2.

Therein, the intermediate unit 4 with all its components forms an insulating layer |that separates a colder zone C from a hotter zone H, where the servo drive unit 3 is located in the colder zone C, and the motor unit 2, including the second printed circuit board 2B in the shown example, is located in the hotter zone H.

In the following, exemplary embodiments of the intermediate unit 4 that specify exemplary details of a motor device 1 as or similar to the motor device 1 of FIG. 1 in corresponding sectional views.

FIG. 2 shows details of an example providing all of the functionalities i)-v) with the injection-mold element 5 being a single-component injection-mold element 5, which is made of a hard, translucent component 5C, and with the second printed circuit board 2B in the hotter zone H as part of the motor unit 2.

In this embodiment, the soft components 5D, 5D′ as seals 4D, 4D′ are pressed against the housings 3A,3B of servo drive unit 3 and motor unit 2, respectively, by the hard component 5C. Thus, the motor device 1 is sealed against an external environment 6. The hard component 5C is mold over the metal sheet 5B that implements the plate-like ferromagnetic shielding element 4B here. The thermal insulation functionality is supported, in this example, by a multitude of blind holes 4F in the hard component 5° C. that are separated by walls 5F formed by the very same hard component 5C here. The blind holes 4F are open in a direction towards the motor unit 2, along the axial direction A, and closed by the second printed circuit board 3B at present. The light guide functionality is provided by the hard component 5C being a transparent hard component, here with one or more protrusions 5C′ that minimize a distance between transparent component 5C and light source 3D in order to guide as much light as possible from the light source 3D to an outer surface 4G of the intermediate unit 4 that is formed by the transparent component 5C.

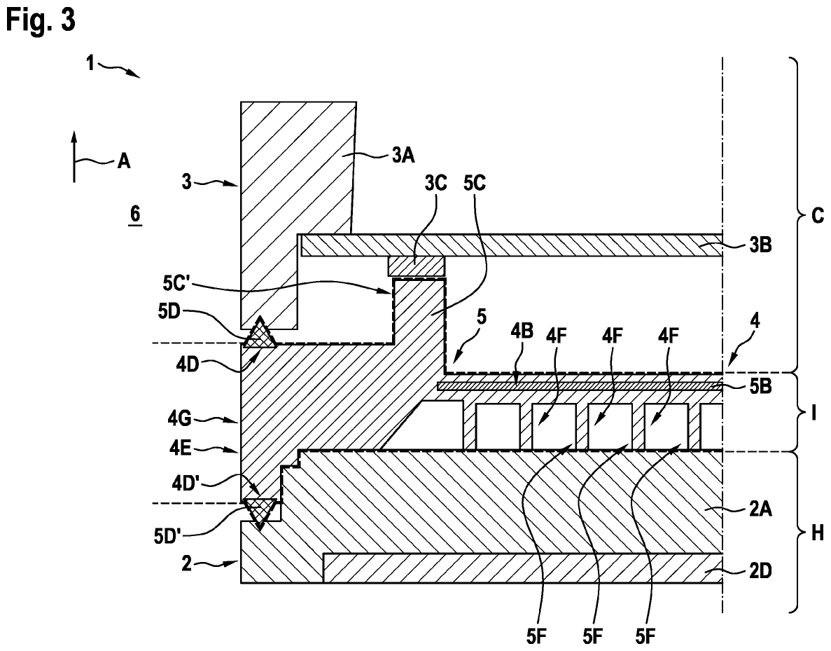

FIG. 3 shows details of an example providing all of the functionalities i)-v) with the single-component injection-mold element 5, and without the second printed circuit board 2B of FIG. 1. Unless described differently, features of this or any of the following examples correspond to one or more of the preceding examples.

As consequence of the lacking second printed circuit board 2B, the blind holes 4F are closed by the housing 2A of the motor unit 2 here.

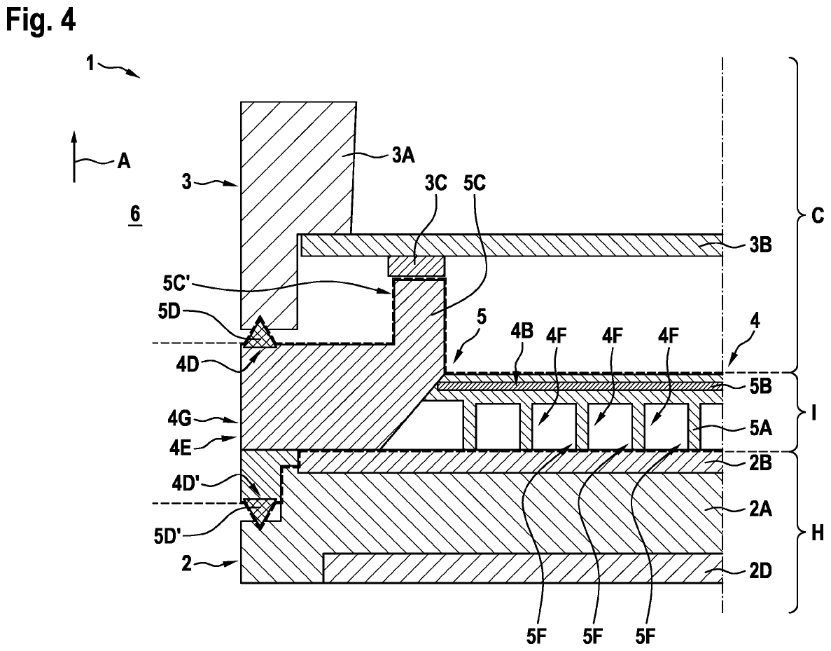

FIG. 4 shows details of an example providing all of the functionalities i)-v) with the injection-mold element 5 being a multi-component injection-mold element 5, which is comprises the hard, translucent component 5C and an other hard component 5A that has a thermal conductivity that is lower than the hard, translucent component 5C, as well as the second printed circuit board 2B in the hotter zone H as part of the motor unit 2.

Therein, the translucent component 5C is used for a peripheral part of the injection-mold element 5, the part between light source 3C and outer surface 4E, but not for the remaining central part of the injection-mold element 5. Consequently, the remaining central part of the injection-mold element 5 is made of the other hard component 5A, in particular the part with the blind holes 4F and/or the part that is mold over the metal sheet 5B.

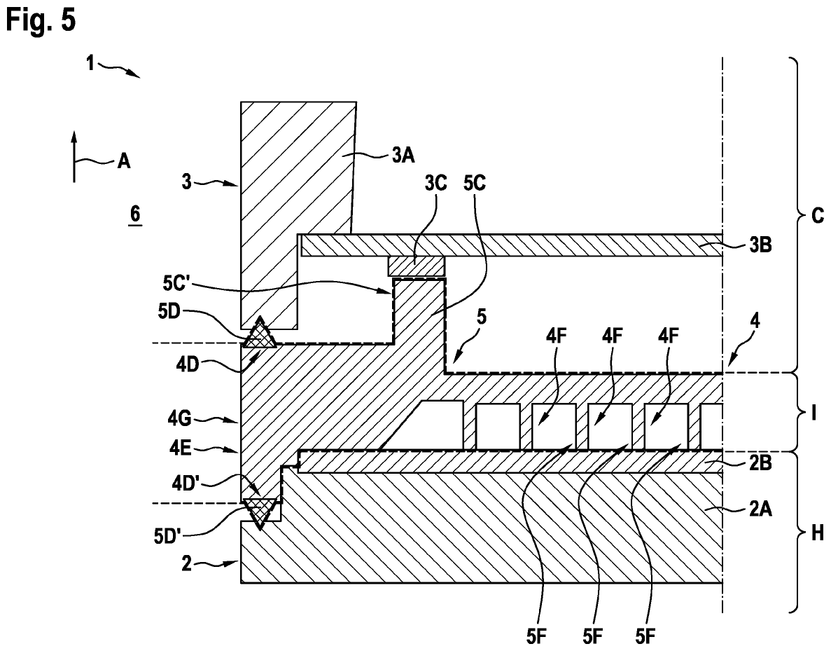

FIG. 5 shows details of an example providing all of the functionalities i)-v) except the electromagnetic shielding functionality, with the single-component injection-mold element 5, and with the second printed circuit board 2B.

Consequently, the motor unit 2 does not comprise the brake 2D, and the intermediate unit 3 does not comprise the metal sheet 5B as ferromagnetic shielding element 4B.

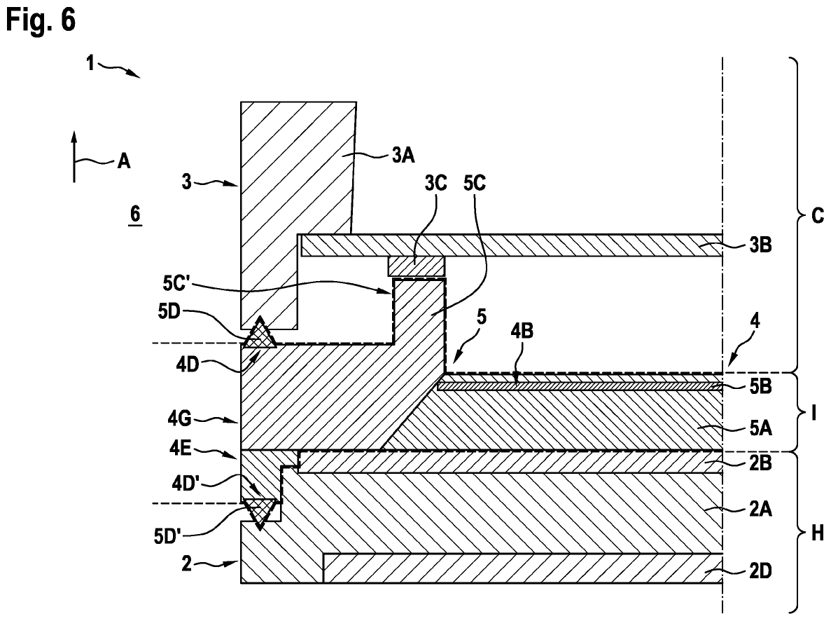

FIG. 6 shows details of an example providing all of the functionalities i)-v) with the multi-component injection-mold element 5 of FIG. 4 which comprises the hard, translucent component 5C and the other hard component 5A, as well as the second printed circuit board 2B in the hotter zone H as part of the motor unit 2.

In contrast to the above example, no blind holes 4F are provided, which results in a solid thermal insulation layer implemented by the other hard component 5A. So, the other hard component 5A is in plain contact with the motor unit 2 here, in the present example with the second printed circuit board 2B.

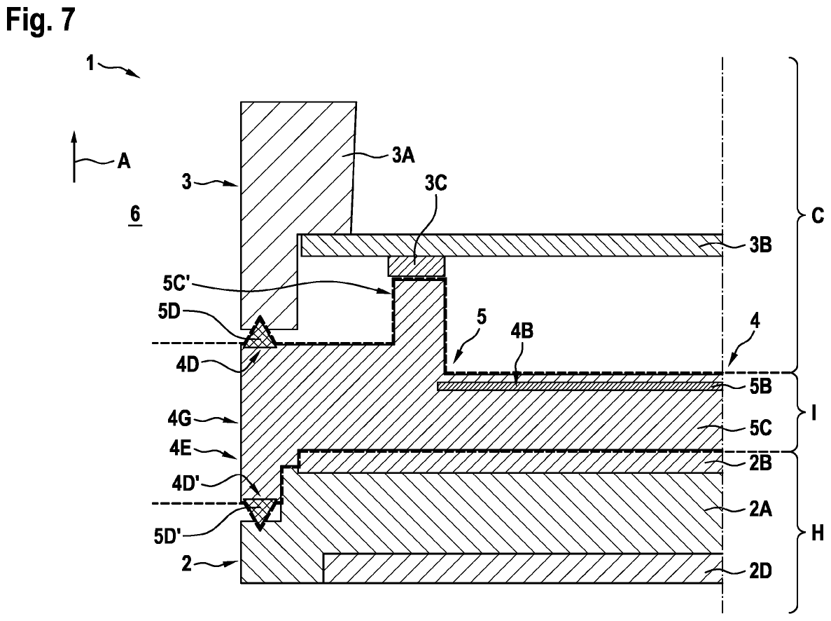

FIG. 7 shows details of another example providing all of the functionalities i)-v) with the injection-mold element 5 being a single-component injection-mold element 5, which is made of a hard, translucent component 5C, and with the second printed circuit board 2B in the hotter zone H as part of the motor unit 2.

As in FIG. 2, the soft components 5D, 5D′ as seals 4D, 4D′ are pressed against the housings 3A,3B of servo drive unit 3 and motor unit 2, respectively, by the hard component 5C. The hard component 5C is mold over the metal sheet 5B that implements the plate-like ferromagnetic shielding element 4B here. Also other features of the example shown here are similar or identical to that of FIG. 2, where differences are described in the following.

In contrast to the example of FIG. 2, the thermal insulation functionality is supported without the multitude of blind holes 4F of FIG. 2. So, the hard component 5C may be referred to as hole-less or massive hard component 5C. The thermal insulation functionality consequently is supported by the material, here a plastic material, of the hard component 5C chosen appropriately such that its thermal conductivity is lower than that of the material of the servo drive housing 3A and/or the material of the motor housing 2A, which may be made of a metal such as aluminium. Here, the plastic forms a plastic layer with a main extension plane perpendicular to the axial direction A.

FIG. 8 shows a perspective view on an exemplary embodiment of an intermediate unit 4. In particular, an exemplary shape of the outer surface 4G with rectangular perimeter with rounded corners is shown. This allows to guide light from the light sources 3C into the environment 6 in all radial directions, i.e. in 360° around the axial direction A. Furthermore, an exemplary shape for the protrusions 5C is shown.

1. motor device with a motor unit and a servo drive unit attached to the motor unit, wherein
the servo drive unit comprises a servo drive housing and a first printed circuit board with one or more electronic elements;
the motor unit comprises a motor housing and a rotor; and
an intermediate unit is arranged between the motor unit and at least a first part of the servo drive unit with a main extension plane perpendicular to an axial direction of the rotor;
characterized in that
the intermediate unit is a multi-functional intermediate unit which comprises an injection-mold element the intermediate unit being configured to provide at least two of the following functionalities:
i) a sealing functionality, with the intermediate unit configured to seal a body of the motor device against an external environment;
ii) an electromagnetic shielding functionality, with the intermediate unit configured to electromagnetically shield at least the first part of the servo drive unit from the motor unit;
iii) a thermal insulation functionality, with the intermediate unit configured to thermally insulate at least the first part of the servo drive unit from the motor unit;
iv) a light guide functionality, with the intermediate unit configured to guide light emitted inside the motor device to the external environment of the motor device and;
v) a load bearing functionality, with the intermediate unit configured to be a load bearing part of the motor device.

2. The motor device of claim 1,
characterized in that
the intermediate unit is configured to provide at least three of the different functionalities of claim 1.

3. The motor device of claim 1
characterized in that,
the injection-mold element is a multi-component injection-mold element which comprises a first soft component that is part of a first circumferential seal a second soft component that is part of a second circumferential seal, and a hard component that is part of a circumferential body section of the body of the motor device; with
the first and second soft components being softer than the hard component; and
the first circumferential seal sealing a gap between the servo drive housing and the circumferential body section; and
the second circumferential seal sealing a gap between the circumferential body section and the motor housing.

4. The motor device of any of claim 1, the claims, comprising a ferromagnetic shielding element, characterized in that,
the ferromagnetic shielding element is overmolded by the injection-mold element. with a main extension plane of the ferromagnetic shielding element running perpendicular to the axial direction.

5. The motor device of claim 1.
characterized in that,
the injection-mold element comprises a plastic, with the plastic having a thermal conductivity lower than the servo drive housing and/or motor housing, and the plastic forms a plastic layer with a main extension plane perpendicular to the axial direction.

6. The motor device of claim 1, characterized in that,
in injection-mold element comprises a multitude of blind holes arranged in a honeycomb structure, with the open side orientated in the same direction towards the motor unit, with the motor housing or a second printed circuit board closing said blind holes.

7. The motor device of claim 1, characterized in that,
in order to provide the light guide functionality, a component of the injection-mold element comprises a translucent material, and is shaped such that a light emitted by at least one light source arranged on the first printed circuit board is guided to an external environment of the motor device

8. The motor device of claim 7,
characterized in that
the translucent material forms an outer surface of the motor device which at least in part runs around the motor device in a circumferential direction for more than 180°.

9. The motor device of claim 7,
characterized in that
the component comprises a first clear section and a second, section, with the first clear section being arranged, along the path of light from the light source to the external environment, between the light source and the second section, and the second section between the clear section and the external environment.

10. The motor device of claim 7,
characterized in that
the at least one light source is several light sources , and the light sources are, in a plane perpendicular to the axial direction, either not arranged on a circle and not arranged on a straight line, or arranged on a circle but not positioned equidistant.

11. motor device of claim 7, characterized in that
the at least one light source is configured to indicate an optical pattern that moves circumferentially around the motor device.

12. The motor device of claim 7,
characterized in that
the translucent material is a translucent plastic, and
the injection-mold element is a multi-component injection-mold element and comprises, in addition to the component of translucent material, a thermally insulating component which comprises a plastic with a thermal conductivity that is lower than the thermal conductivity of the translucent plastic.

13. The motor device of claim 12,
characterized in that
the component of translucent plastic has a non-circular outer perimeter.

14. The motor device of claim 1,
characterized in that,
in the injection-mold element, comprises an alignment structure for aligning the servo drive unit and/or the motor unit with the intermediate unit using a form-fit mechanical interaction with the servo drive unit.

15. A combination of the intermediate unit, the servo drive unit, and the motor unit of claim 1, for a motor device.

16. The motor device of claim 14,
characterized in that,
the alignment structure aligns the servo drive unit and/or the motor unit with the intermediate unit using a form-fit mechanical interaction with the servo drive housing and/or the first printed circuit board, and/or the motor unit.

17. The motor device of claim 14,
characterized in that,
the alignment structure aligns the servo drive unit and/or the motor unit with the intermediate unit using a form-fit mechanical interaction with the servo drive housing and/or the first printed circuit board, and/or the motor housing and/or the second printed circuit board.
